(19) United States
(12) Patent Application Publication
(10) Pub. No.: US 2024/0302724 A1
(43) Pub. Date: Sep. 12, 2024

(54) PROJECTION APPARATUS AND DISPLAY SYSTEM

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Xiaojuan WU, Beijing (CN); Yujie WANG, Beijing (CN); Yao BI, Beijing (CN); Jian WANG, Beijing (CN); Yu ZHAO, Beijing (CN); Jiaxing WANG, Beijing (CN); Jinshuai DUAN, Beijing (CN); Dawei FENG, Beijing (CN); Zhiqiang YU, Beijing (CN); Feng LIU, Beijing (CN); Cuiyu CHEN, Beijing (CN); Yichi ZHANG, Beijing (CN)

(21) Appl. No.: 18/028,116

(22) PCT Filed: Jun. 29, 2022
(86) PCT No.: PCT/CN2022/102167

§ 371 Date: Mar. 23, 2023

(51) Int. Cl. G03B 21/00; G02F 1/1337; G02F 1/1343; G03B 21/20

(52) U.S. Cl. CPC G03B 21/006; G02F 1/133769; G02F 1/134309; G03B 21/208

(57) ABSTRACT

There is provided a projection apparatus, including: a light emitting component configured to generate light; a liquid crystal display panel on a light outgoing side of the light emitting component and including a liquid crystal layer between a first substrate and a second substrate, the liquid crystal layer including cholesteric liquid crystals configured to be in a conical helix texture under an electric field applied, so as to reflect light matched with a helix pitch of the conical helix texture; an optical component between the light emitting component and the liquid crystal display panel, and configured to adjust a propagation direction of light, an acute angle being formed between an optical axis of the optical component and a normal of the liquid crystal display panel; and a projection lens configured to receive and project the light reflected by the liquid crystal display panel. A display system is further provided.

### TECHNICAL FIELD

The present disclosure relates to the field of display technology, in particular to a projection apparatus and a display system.

### BACKGROUND

With the development of the liquid crystal display technology, display screens are more and more widely applied in the field of projectors. The liquid crystal display screen has the advantages of customizable design in size and resolution, single liquid crystal cell, realizing color with a single light path, relatively low cost, simple light path during being applied to a projector and the like, so that the application of the liquid crystal display screen in the field of projectors is increasingly enhanced in recent years.

### SUMMARY

In a first aspect, an embodiment of the present disclosure provides a projection apparatus, including: a light emitting component configured to generate light; a liquid crystal display panel on a light outgoing side of the light emitting component, and including a first substrate, a second substrate and a liquid crystal layer between the first substrate and the second substrate, the liquid crystal layer including cholesteric liquid crystals, and the cholesteric liquid crystals being configured to be in a conical helix texture under an electric field applied, so as to reflect light matched with a helix pitch of the conical helix texture; an optical component between the light emitting component and the liquid crystal display panel, and configured to adjust a propagation direction of light, an angle between an optical axis of the optical component and a normal of the liquid crystal display panel being an acute angle; and a projection lens configured to receive and project the light reflected by the liquid crystal display panel.

In some implementations, the optical component includes: a collimating and light-extracting component, the collimating and light-extracting component is between the light emitting component and the liquid crystal display panel, and is configured to adjust light irradiated to the collimating and light-extracting component into the collimated light and emit the collimated light to the liquid crystal display panel.

In some implementations, the collimating and light-extracting component includes a first Fresnel lens.

In some implementations, the optical component further includes: a first light focusing component, the first light focusing component is between the light emitting component and the collimating and light-extracting component, and is configured to focus the light irradiated to the first light focusing component to the collimating and light-extracting component.

In some implementations, an optical axis of the collimating and light-extracting component and an optical axis of the first light focusing component are on a same straight line.

In some implementations, the projection apparatus further includes: a second light focusing component, the second light focusing component is between the projection lens and the liquid crystal display panel, and is configured to focus the light irradiated to the second light focusing component onto the projection lens.

In some implementations, an optical axis of the second focusing component is parallel to an optical axis of the projection lens.

In some implementations, the second light focusing component includes a second Fresnel lens.

In some implementations, the optical axis of the second light focusing component is parallel to the normal of the liquid crystal display panel.

In some implementations, the collimating and light-extracting component includes a first Fresnel lens, and the second light focusing component includes a second Fresnel lens; and a diameter of the first Fresnel lens is W1, and a diameter of the second Fresnel lens is W2, and W1≤W2.

In some implementations, a maximum width of a display region of the liquid crystal display panel is W0, and W1≤W0≤W2.

In some implementations, an angle β is formed between the optical axis of the collimating and light-extracting component and the normal of the liquid crystal display panel, B is an acute angle, an angle formed between the optical axis of the second light focusing component and the normal of the liquid crystal display panel is equal to the angle between the optical axis of the collimating and light-extracting component and the normal of the liquid crystal display panel; and the optical axis of the second light focusing component and the optical axis of the collimating and light-extracting component intersect at a first node, and an angle 2β is formed between a ray directed from the first node to the second light focusing component along the optical axis of the second light focusing component and a ray directed from the first node to the collimating and light-extracting component along the optical axis of the collimating and light-extracting component.

In some implementations, the first node is a center of a display region of the liquid crystal display panel.

In some implementations, the collimating and light-extracting component includes a first Fresnel lens and the second light focusing component includes a second Fresnel lens; and a diameter of the first Fresnel lens is W1, a diameter of the second Fresnel lens is W2, and W2≤W1.

In some implementations, a maximum width of a display region of the liquid crystal display panel is W0, and W2≤W1≤W0.

In some implementations, an angle formed between the collimated light reflected by the liquid crystal display panel and received by the second light focusing component and the normal of the liquid crystal display panel, and an angle formed between the collimated light emitted by the collimating and light-extracting element toward the liquid crystal display panel and the normal of the liquid crystal display panel are equal to each other.

In some implementations, an angle θ is formed between the collimated light emitted from the collimating and light-extracting component toward the liquid crystal display panel and the normal of the liquid crystal display panel: 0°<θ≤80º.

In some implementations, 30°≤θ≤70°.

In some implementations, 45°≤θ≤60°.

In some implementations, an angle β is formed between the optical axis of the collimating and light-extracting component and the normal of the liquid crystal display panel, β=θ.

In some implementations, the first substrate includes: a first base substrate, a first electrode on a side of the first base substrate facing the second substrate, and a first alignment layer on a side of the first electrode away from the first base substrate: the second substrate includes: a second base substrate, a driving functional layer on a side of the second base substrate facing the first substrate, a plurality of second electrodes on a side of the driving functional layer away from the second base substrate, and a second alignment layer on a side of the plurality of second electrodes away from the second base substrate; and the driving functional layer includes a plurality of driving circuits in one-to-one correspondence with the plurality of second electrodes, each driving circuit is connected to the second electrode corresponding thereto, and configured to supply a pixel voltage to the second electrode.

In some implementations, the cholesteric liquid crystals include: nematic liquid crystals, chiral additives and bent oligomers.

In a second aspect, an embodiment of the present disclosure further provides a display system, including: the projection apparatus as provided in the first aspect.

In some implementations, the display system further includes: a projection screen on a light outgoing side of the projection lens.

### BRIEF DESCRIPTION OF DRAWINGS

FIG. 1 is a schematic diagram of a structure of a projection apparatus according to an embodiment of the present disclosure;

FIG. 2 is a schematic cross-sectional view of a liquid crystal display panel according to an embodiment of the present disclosure:

FIG. 3 is a schematic diagram of a cholesteric liquid crystal in a focal conic texture according to an embodiment of the present disclosure;

FIG. 4 is a schematic diagram of a cholesteric liquid crystal in a conical helix texture according to an embodiment of the present disclosure;

FIG. 5A is a schematic diagram of a structure of another projection apparatus according to an embodiment of the present disclosure;

FIG. 5B is a schematic diagram of an optical path of the projection apparatus shown in FIG. 5A;

FIG. 6 is a schematic diagram illustrating a curve of a relationship between an angle of reflected light and a color gamut for incident light at different incident angles according to an embodiment of the present disclosure;

FIGS. 7A and 7B are schematic diagrams illustrating two cases in which light is incident to a liquid crystal display panel at a relatively large incident angle according to an embodiment of the present disclosure:

FIG. 8A is a schematic diagram of a structure of another projection apparatus according to an embodiment of the present disclosure;

FIG. 8B is a schematic diagram of an optical path of the projection apparatus shown in FIG. 8A;

FIG. 9A is a schematic diagram of a structure of another projection apparatus according to an embodiment of the present disclosure;

FIG. 9B is a schematic diagram of an optical path of the projection apparatus shown in FIG. 9A; and

FIG. 10 is a schematic diagram of a structure of a display system according to an embodiment of the present disclosure.

### DETAIL DESCRIPTION OF EMBODIMENTS

Reference will now be made in detail to exemplary embodiments of the present disclosure, examples of which are illustrated in the accompanying drawings. Wherever possible, the same reference number will be used throughout the drawings to refer to the same or like parts.

Advantages and features of the present disclosure and methods of implementing the same will be set forth in the following description of embodiments with reference to the accompanying drawings. However, the present disclosure may be embodied in different forms and should not be construed as limited to the embodiments set forth herein. Rather, these embodiments are provided so that this disclosure will be thorough and complete, and will fully convey the scope of the present disclosure to those ordinary skills in the art. In addition, the present disclosure is limited only by the scope of the claims.

Shapes, sizes, ratios, angles, and numbers disclosed in the drawings for describing embodiments of the present disclosure are only examples, and thus, the present disclosure is not limited to the illustrated details. Like reference numerals refer to like elements throughout. In the following description, if it is determined that a detailed description of related known functions or configurations unnecessarily obscures the gist of the present disclosure, the detailed description will be omitted.

In the case of using “including”, “having”, and “comprising” described in this specification, other parts may be included unless being used together with “only”. Singular terms may include the plural forms unless described to the contrary.

For illustrating an element, (a dimension of) the element is to be construed as being in an error range although not explicitly described.

In the description of the embodiments of the present disclosure, if a structure (e.g., an electrode, a line, a wiring, a layer, or a contact) is described as being formed on/under an lower portion/upper portion of another structure or any other structure, this description should be understood to include a case where these structures are in contact with each other, and further include a case where a third structure is provided therebetween.

In describing the temporal relationship, for example, if the temporal order is described as “after”. “subsequently”. “next”, and “before”, the case of discontinuity may be included unless being used together with “exactly” or “immediately”.

It will be understood that although the terms “first”, “second”, etc. may be used herein to describe various elements, these elements should not be limited by these terms. These terms are only used to distinguish one element from another. For example, a first element may be termed a second element, and similarly, a second element may be termed a first element, without departing from the scope of the present disclosure.

The features of the embodiments of the present disclosure may be connected or combined with each other, in part or in whole, and may be inter-operated and technically driven in various ways, as will be well understood by those ordinary skills in the art. Embodiments of the present disclosure may be performed independently of one another or may be performed simultaneous according to inter-dependences among them.

Hereinafter, example embodiments of the present disclosure will be described in detail with reference to the accompanying drawings.

In the related art, during a liquid crystal display (LCD) panel being applied to a projector, colors in a projection picture are realized by a color filter in the LCD panel. In order to realize a display in a high color gamut, a thickness of the color filter is usually designed to be relatively thick, which results in a relatively low light transmittance and thus a relatively low light utilization rate. Further, a polarizer is used for adjusting gray scales, which further reduces the light utilization rate. In addition, since the color filter absorbs light having complementary wavelengths according to the color principle, a temperature of the liquid crystal display panel is increased by the heat absorbed by the color filter in a condition of a light source having a high brightness, which affects the performance of the liquid crystal display panel.

In order to effectively improve at least one technical problem existing in the related art, the present disclosure provides a new LCD-based projection apparatus, which can implement a color display in a high color gamut without a color filter: meanwhile, the projection apparatus also has a relatively high light utilization rate.

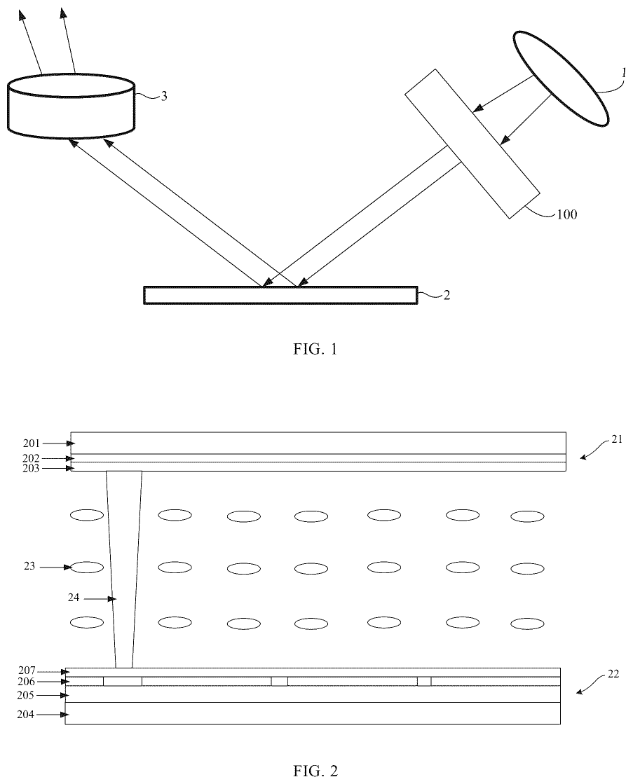

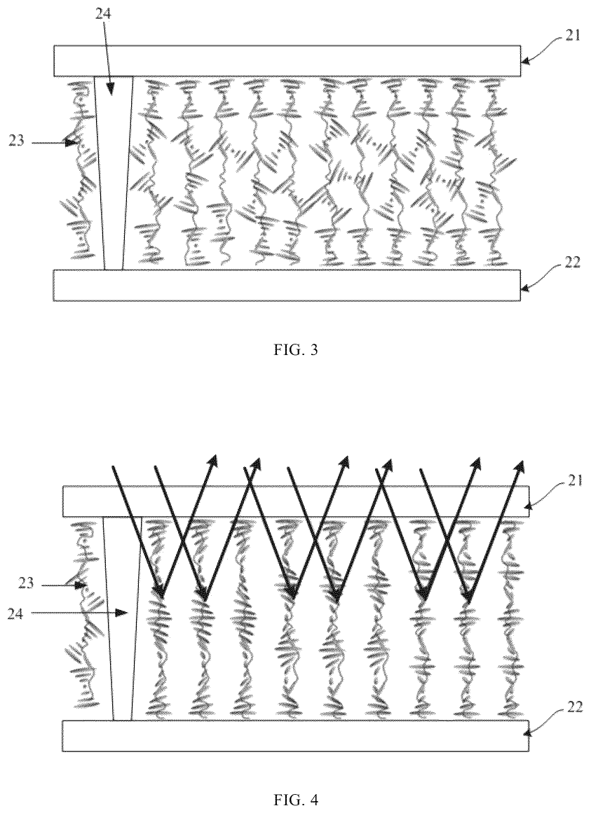

FIG. 1 is a schematic diagram of a structure of a projection apparatus according to an embodiment of the present disclosure: FIG. 2 is a schematic cross-sectional view of a liquid crystal display panel according to an embodiment of the present disclosure: FIG. 3 is a schematic diagram of a cholesteric liquid crystal in a focal conic texture according to an embodiment of the present disclosure: FIG. 4 is a schematic diagram of a cholesteric liquid crystal in a conical helix texture according to an embodiment of the present disclosure. As shown in FIGS. 1 to 4, the projection apparatus includes: a light emitting component 1, a liquid crystal display panel 2, an optical component 100 and a projection lens 3.

The light emitting component 1 is configured to generate light.

The liquid crystal display panel 2 is located on a light outgoing side of the light emitting component 1, and includes: a first substrate 21, a second substrate 22 and a liquid crystal layer 23 located between the first substrate 21 and the second substrate 22, the liquid crystal layer 23 includes cholesteric liquid crystals, and the cholesteric liquid crystals are configured to be in a conical helix texture under an electric field applied, so as to reflect light matched with a helix pitch of the conical helix texture.

The optical component 100 is located between the light emitting component and the liquid crystal display panel, and is configured to adjust a propagation direction of light, and an angle formed between an optical axis of the optical component 100 and a normal of the liquid crystal display panel is an acute angle.

The projection lens 3 is configured to receive and project the light reflected by the liquid crystal display panel 2.

In the embodiment of the present disclosure, the liquid crystal display panel 2 is a liquid crystal display panel 2 based on a cholesteric liquid crystal layer. The cholesteric liquid crystals include a plurality of layers of molecules, the molecules in each layer are arranged in a same direction, but are arranged in a direction slightly rotated with respect to the direction in which the molecules of another layer adjacent to said each layer are arranged, the plurality of layers are stacked together into a helix structure. The direction in which the molecules of the layer at an end of each helix pitch are arranged is rotated by 360 degrees with respect to the direction in which the molecules of the layer at another end of the helix pitch are arranged. In a case where the cholesteric liquid crystals are in the conical helix texture, the cholesteric liquid crystals have selective specular reflection characteristics. Particularly, the cholesteric liquid crystals follow the Bragg's law: λ=n×p, where n is an average refractive index of the cholesteric liquid crystals, n=(nₒ+n_{c})/2, and p is the helix pitch of the cholesteric liquid crystals. A wavelength width of the reflected light is Δλ=Δn*p, Δn=n_{c}−nₒ, n_{c} is an extraordinary light refractive index of the cholesteric liquid crystals, n_{c} is an ordinary light refractive index of the cholesteric liquid crystals. If the helix pitch of the cholesteric liquid crystals is fixed, light in a specific wavelength band corresponding to the helix pitch is reflected, so that a corresponding color is presented. Therefore, the color of the light reflected by the cholesteric liquid crystals can be controlled by adjusting the helix pitch of the cholesteric liquid crystals (with different helix pitches, light with different colors can be reflected).

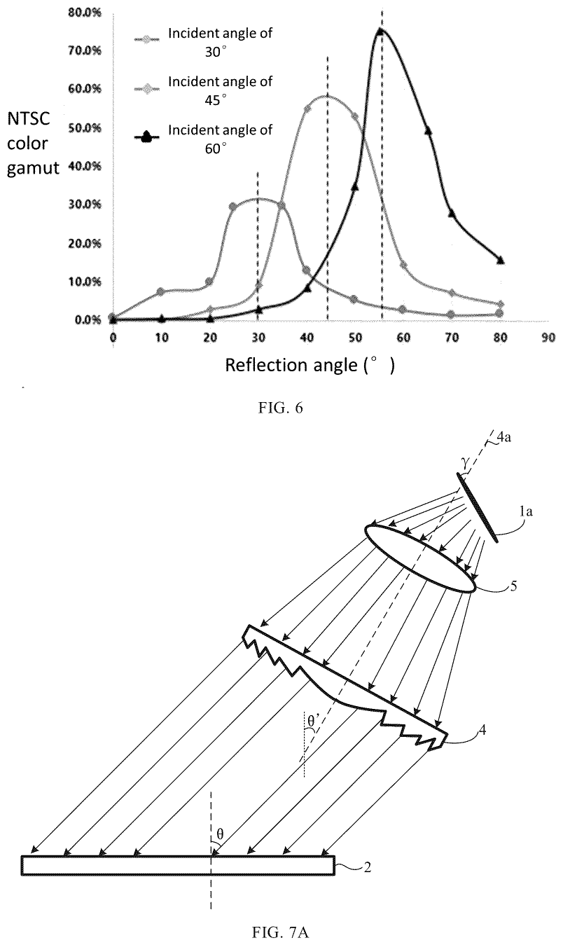

In the embodiment of the present disclosure, the electric field may be used to control the helix pitch of the cholesteric liquid crystals in the conical helix texture in the liquid crystal display panel 2, so as to control the color of the light emitted through a specular reflection of the cholesteric liquid crystals, and realize the color display. Due to the special conical helix texture of the cholesteric liquid crystals in the present disclosure, during viewing at an angle of specular reflection for the incident light, best optical properties (referring to the related description for FIG. 6 below), such as the reflectivity and the color, can be achieved. Therefore, the color of emitted light is controlled based on the specular reflection of the cholesteric liquid crystals, and the relatively high light utilization rate is achieved.

The process of color picture projecting performed by the projection apparatus provided in the embodiment of the present disclosure is as follows: the light emitting component 1 may emit the visible light; after the visible light is irradiated to the liquid crystal display panel 2, the cholesteric liquid crystals at various positions in the liquid crystal display panel 2 reflect the light with the wavelength matched with the helix pitch in the visible light according to the helix pitch of the conical helix texture, so that a color display picture in the high color gamut is presented; the projection lens 3 receives and projects the light reflected by the liquid crystal display panel 2, that is, the picture projection is realized.

Based on the above, the technical solution of the present disclosure can realize the color picture projection in the high color gamut without any color filter: in addition, the cholesteric liquid crystals in the conical helix texture have a high reflectivity (approximate to 50%) for the light with a selected wavelength, so that the projection apparatus entirely has the relatively high light utilization rate.

In the embodiment of the present disclosure, the light emitting component 1 may include a plurality of light emitting elements. In some implementations, each light emitting element may include a light emitting diode (LED), for example, an LED with a relatively small size, such as a micro light emitting diode (micro LED) or a mini light emitting diode (Mini LED), may be used so that the light emitting element has a relatively high collimation. The number, sizes, arrangement and the like of the light emitting elements in the light emitting component 1 may be set by those ordinary skills in the art according to practical situations, which is not limited in the present disclosure.

In some implementations, to realize the full color display, the light emitted by the light emitting component 1 is white light, the white light is a mixed light, and has a wavelength in a range from 390 nm to 770 nm in the visible light region.

Referring to FIG. 2, in some implementations, the first substrate 21 includes a first base substrate 201, a first electrode 202 positioned on a side of the first base substrate 201 facing the second substrate 22, and a first alignment layer 203 positioned on a side of the first electrode 202 away from the first base substrate 201; the second substrate 22 includes a second base substrate 204, a driving functional layer 205 located on a side of the second base substrate 204 facing the first substrate 21, a plurality of second electrodes 206 located on a side of the driving functional layer 205 away from the second base substrate 204, and a second alignment layer 207 located on a side of the plurality of second electrodes 206 away from the second base substrate 204; the driving functional layer 205 includes a plurality of driving circuits (not shown) in one-to-one correspondence with the plurality of second electrodes 206, each driving circuit is connected to the second electrode 206 corresponding thereto, and configured to supply a pixel voltage to the second electrode.

In general, a spacer 24 is further provided between the first substrate 21 and the second substrate 22.

Each of the first base substrate 201 and the second base substrate 204 may be a hard base substrate or a flexible base substrate independently. The hard base substrate may be a glass substrate, and the flexible base substrate may be a resin substrate.

In the embodiment of the present disclosure, the first electrode 202 is located on the first base substrate 201, and the second electrodes 206 are located on the second base substrate 204. As a specific example, the first electrode 202 may be a planar electrode, that is, the first electrode 202 is planar and laid in an entire planar layer, and the first electrode 202 may serve as a common electrode; the plurality of second electrodes 206 may be plate-shaped electrodes, and are arranged in an array on the second base substrate, and the second electrodes 206 may be used as pixel electrodes, in such case, the liquid crystal display panel 2 is in a twisted nematic (TN) display mode. Each of the first electrode 202 and the second electrode 206 may be a transparent electrode, for example, made of a metal oxide (e.g., ITO, IZO, IGZO, etc.).

Referring to FIG. 3, during no electric field being formed between the first electrode 202 and each second electrode 206, the cholesteric liquid crystals are in a focal conic texture, and scatter the incident light, referring to FIG. 4, during different voltages being applied to the first electrode 202 and the second electrodes 206 to form an electric field therebetween, the cholesteric liquid crystals in the electric field is transformed from the focal conic texture to the conical helix texture, so that incident visible light with the wavelength matched with the helix pitch of the conical helix texture can be reflected, and the visible light of different colors can be reflected under different electric fields, thereby realizing the color display.

Each driving circuit connected to the second electrode 206 corresponding thereto generally includes a thin film transistor and a storage capacitor, and is configured to write the pixel voltage supplied from the data line into the second electrode 206. The technical solution of the present disclosure does not limit the specific circuit structure of the driving circuit.

In some implementations, the cholesteric liquid crystals are a mixture including nematic liquid crystals, chiral additives and bent oligomers. By adding the chiral additives and the bent oligomers into the nematic liquid crystals, orientations of liquid crystal molecules are twisted from a nematic phase to a cholesteric phase.

In some implementations, the nematic liquid crystals may include CB-based liquid crystals such as 5CB, 7CB or 8CB, or may be conventional nematic mixed crystals for display.

In some implementations, the bent oligomers may be bent oligomers with a relatively low molecular weight, such as bent dimers, bent trimers.

As an example, two types of bent dimer compounds (referred to as a first bent dimer compound and a second bent dimer compound, respectively) and one bent trimer compound are included in the mixture of the cholesteric liquid crystals.

As an alternative example, a molecular formula of the first bent dimer compound may be as follows:

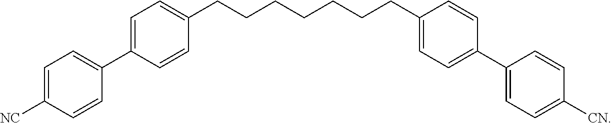 [SMILES: N#Cc1ccc(-c2ccc(CCCCCCCc3ccc(-c4ccc(C#N)cc4)cc3)cc2)cc1]

A molecular formula of the second bent dimer compound may be as follows:

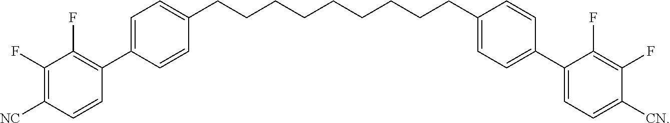 [SMILES: N#Cc1ccc(-c2ccc(CCCCCCCCCc3ccc(-c4ccc(C#N)c(F)c4F)cc3)cc2)c(F)c1F]

A molecular formula of the bent trimer compound may be as follows:

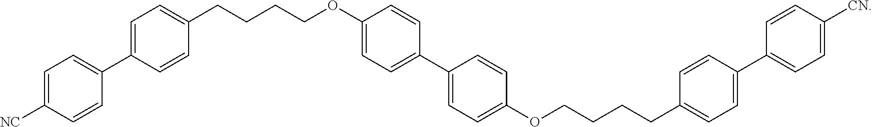 [SMILES: N#Cc1ccc(-c2ccc(CCCCOc3ccc(-c4ccc(OCCCCc5ccc(-c6ccc(C#N)cc6)cc5)cc4)cc3)cc2)cc1]

A molecular formula of the chiral additives may be as follows:

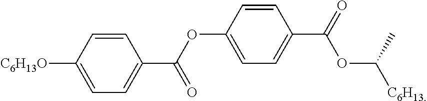

As an example, the first bent dimer compound, the second bent dimer compound, the bent trimer compound, the chiral additives, and a nematic liquid crystal mixture SLC1717 may be uniformly mixed in a mass ratio of 38%/5%/7%/5%/45% to obtain the mixture of the cholesteric liquid crystals.

In some implementations, the first alignment layer 203 is provided on the first substrate 21, the second alignment layer 207 is provided on the second substrate 22, and the first alignment layer 203 and the second alignment layer 207 may be oriented vertically or parallelly.

It should be noted that the liquid crystal display panel 2 in the embodiment of the present disclosure does not include a polarizer, so that there is no problem in the embodiment of the present disclosure that the light utilization rate of the product is reduced due to the polarizer as that in the related art.

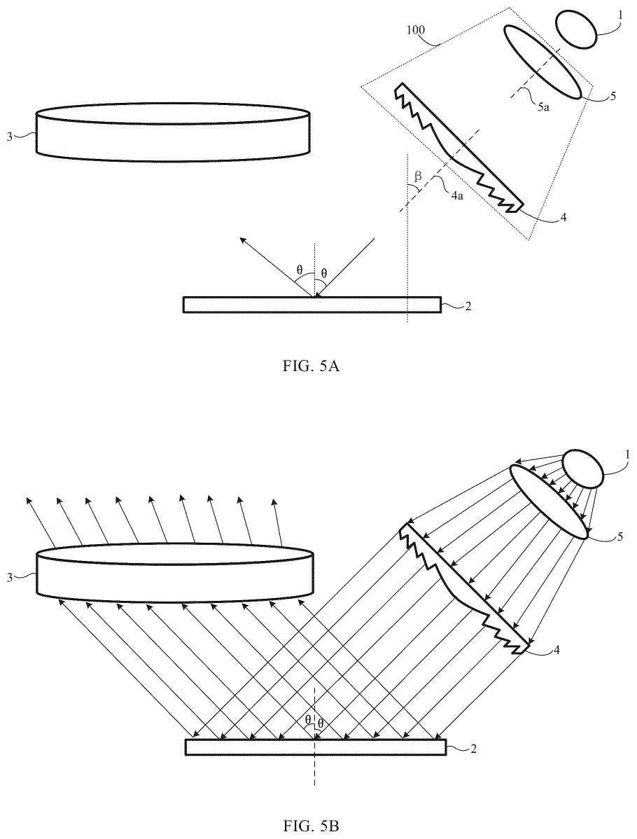

FIG. 5A is a schematic diagram of a structure of another projection apparatus according to an embodiment of the present disclosure: FIG. 5B is a schematic diagram of an optical path of the projection apparatus shown in FIG. 5A. As shown in FIGS. 5A and 5B, in some implementations, the optical component 100 includes: a collimating and light-extracting component 4, the collimating and light-extracting component 4 is positioned between the light emitting component 1 and the liquid crystal display panel 2, and is configured to adjust light irradiated to the collimating and light-extracting component 4 into the collimated light and emit the collimated light to the liquid crystal display panel 2.

It should be noted that the light with a divergence angle less than or equal to 10° in the embodiment of the present disclosure may be collimated light in the embodiment of the present disclosure.

In the embodiment of the present disclosure, the collimating and light-extracting component 4 is provided, such that most of the light emitted by the light emitting component 1 can be collimated to be emitted, which can effectively improve the light utilization rate of the light emitting elements.

In some implementations, the collimating and light-extracting component 4 includes a first Fresnel lens. The first Fresnel lens may include: a central portion corresponding to a circular shape at a center of a Fresnel zone and an annular portion corresponding to an annular shape of the Fresnel zone.

In some implementations, by taking the collimating and light-extracting component 4 being a Fresnel lens as an example, the light emitting elements may be located at a focal point of the collimating and light-extracting component 4 (i.e., the Fresnel lens). Here, it can be seen from the basic properties of the lens that the light emitted from the focal point can be collimated to be emitted by passing through the collimating and light-extracting component 4 (i.e. the Fresnel lens), and a desired collimating effect can be achieved.

FIG. 6 is a schematic diagram illustrating a curve of a relationship, between an angle of reflected light and a color gamut, for incident light at different incident angles according to an embodiment of the present disclosure. As shown in FIG. 6, in the embodiment of the present disclosure, the liquid crystal display panel 2 is optically tested to test the relationship between the reflected light at different reflection angles, for the incident light at different incident angles, and the color gamut obtained, the incident angle of incident light or the reflection angle of reflected light described in the present disclosure each refer to an angle between the corresponding light and the normal of the liquid crystal display panel 2.

It should be noted that for the incident light at a fixed incident angle, the process of testing the color gamut obtained corresponding to the reflected light at different reflection angles is as follows: the liquid crystal display panel is horizontally placed on a base platform of an optical detection device, the incident light is irradiated to the panel at a certain angle (such as 30°, 45°, 60° and any other angle), reflected light signals are received at different receiving angles to test color coordinates, and then the color gamut corresponding to the different receiving angles is calculated through a formula based on detected color coordinates.

In the above test, the liquid crystal layer in the liquid crystal display panel 2 contains following components in a mass ratio including 55% of nematic liquid crystals. 40% of a bent oligomer mixture and 5% of chiral additives.

Referring to FIG. 6, for the incident light at the incident angle of 30°, the maximum color gamut of about 31% of NTSC color gamut can be obtained corresponding to the reflected light at the reflection angle of 30°; for the incident light at the incident angle of 45°, the maximum color gamut of about 58% of the NTSC color gamut can be obtained corresponding to the reflected light at the reflection angle of 40°; and for the incident light at the incident angle of 60°, the maximum color gamut about 75% of the NTSC color gamut can be obtained corresponding to the reflected light at the reflection angle of 60°.

As can be seen from above test results, with the angle (i.e., the incident angle of incident light) of θ formed between the collimated light emitted from the collimating and light-extracting component 4 toward the liquid crystal display panel 2 and the normal of the liquid crystal display panel 2, the maximum color gamut can be obtained by receiving the reflected light at the reflection angle of θ. The larger the 0) is, the larger the maximum color gamut obtained by receiving the reflected light at the reflective light angle of θ is.

FIGS. 7A and 7B are schematic diagrams illustrating two cases in which the light is incident to a liquid crystal display panel at a relatively large incident angle according to an embodiment of the present disclosure. As shown in FIGS. 7A and 7B, in practical applications, the relatively large incident angle θ of the light is generally achieved in the following two ways.

Referring to FIG. 7A, in a first way, an optical axis 4a of the collimating and light-extracting component 4 is provided such that an angle θ′ smaller than θ is formed between the optical axis 4a and the normal of the liquid crystal display panel 2, and then a light outgoing surface 1a of the light emitting component 1 is provided such that a certain angle γ is formed between the optical axis 4a of the collimating and light-extracting component 4 and the light outgoing surface 1a, so that the incident angle of the collimated light emitted by the collimating and light-extracting component 4 is θ (the collimated light emitted by the collimating and light-extracting component 4 is incident to the liquid crystal display panel 2 at the incident angle of θ). In such case, a certain angle is formed between the optical axis 4a of the collimating and light-extracting component 4 and the collimated light emitted by the collimating and light-extracting component 4.

Referring to FIG. 7B, in a second way, the optical axis 4a of the collimating and light-extracting component 4 is provided such that the angle θ is formed between the optical axis 4a and the normal of the liquid crystal display panel 2, and then the light outgoing surface 1a of the light emitting component 1 is provided such that the light outgoing surface 1a is perpendicular to the optical axis 4a of the collimating and light-extracting component 4, so that the incident angle of the collimated light emitted by the collimating and light-extracting component 4 is θ. In such case, the collimated light emitted from the collimating and light-extracting component 4 is parallel or substantially parallel to the optical axis 4a of the collimating and light-extracting component 4.

In the first way, since the light outgoing surface 1a of the light emitting component 1 is not perpendicular to the optical axis 4a of the collimating and light-extracting component 4, on one hand, the light utilization rate is relatively low, and on the other hand, the divergence degree of the light finally emitted by the collimating and light-extracting component 4 is relatively high (the collimating effect is poor), which affects the final display effect.

In the second way, the light outgoing surface 1a of the light emitting component 1 is perpendicular to the optical axis 4 of the collimating and light-extracting component 4, which can solve the problems of low light utilization rate and high divergence degree of the emitted light. However, since a relatively large angle is formed between the optical axis of the collimating and light-extracting component 4 and the normal of the liquid crystal display panel 2, the collimating and light-extracting component 4 is desired to be provided at a position far away from the liquid crystal display panel 2 (if the distance between the collimating and light-extracting component 4 and the liquid crystal display panel 2 is relatively small, the light emitted by the collimating and light-extracting component 4 is difficult to completely cover the liquid crystal display panel 2 entirely), which would result in a too large overall size of the entire projection apparatus.

Therefore, in practical applications, the angle θ between the collimated light emitted from the collimating and light-extracting component 4 toward the liquid crystal display panel 2 and the normal of the liquid crystal display panel 2 should not be too large. In some implementations, 0°<θ≤80°. In some implementations, 30°≤θ≤70°. In some implementations, as desired for the color gamut and the size of the projection apparatus, 45°≤θ≤60°.

In some implementations, an angle β is formed between the optical axis 4a of the collimating and light-extracting component 4 and the normal of the liquid crystal display panel 2, where β=θ. That is to say, the above second way is adopted, in such case, the light outgoing surface of the light emitting component 1 is perpendicular to the optical axis 4a of the collimating and light-extracting component 4, and the collimated light emitted by the collimating and light-extracting component 4 is parallel or substantially parallel to the optical axis 4a of the collimating and light-extracting component 4, so that the light utilization rate can be effectively improved.

In some implementations, the optical component 100 further includes, a first light focusing component 5, the first light focusing component 5 is positioned between the light emitting component 1 and the collimating and light-extracting component 4, and the first light focusing component 5 is configured to focus the light irradiated to the first light focusing component 5 to the collimating and light-extracting component 4.

In some implementations, the first light focusing element 5 may be a convex lens.

In the embodiment of the present disclosure, the first light focusing component 5 is disposed between the light emitting component 1 and the collimating and light-extracting component 4, so that light emitted by the light emitting component 1 is converged firstly, and then emitted toward a direction approaching the collimating and light-extracting component 4 in a light beam with a relatively small divergence degree. In this way, the light utilization rate can be effectively improved, and a size of the collimating and light-extracting component 4 can be reduced, so that miniaturization and light weight and thinness of the entire product can be realized

In some implementations, the optical axis 4a of the collimating and light-extracting component 4 and an optical axis of the first light focusing component 5 are on a same straight line. By providing the optical axis 4a of the collimating and light-extracting component 4 and the optical axis Sa of the first light focusing component 5 on a same straight line (the collimating and light-extracting component 4 and the first light focusing component 5 correspond to the same optical axis), the light utilization rate can be improved.

It should be noted that in a case where the first light focusing component 5 is provided between the collimating and light-extracting component 4 and the light emitting component 1, a center of a light outgoing surface of the first light focusing component 5 may be located at a focal point of the collimating and light-extracting component 4; and a center of the light outgoing surface of the light emitting component 1 may also be located at a focus point of the first light focusing component 5.

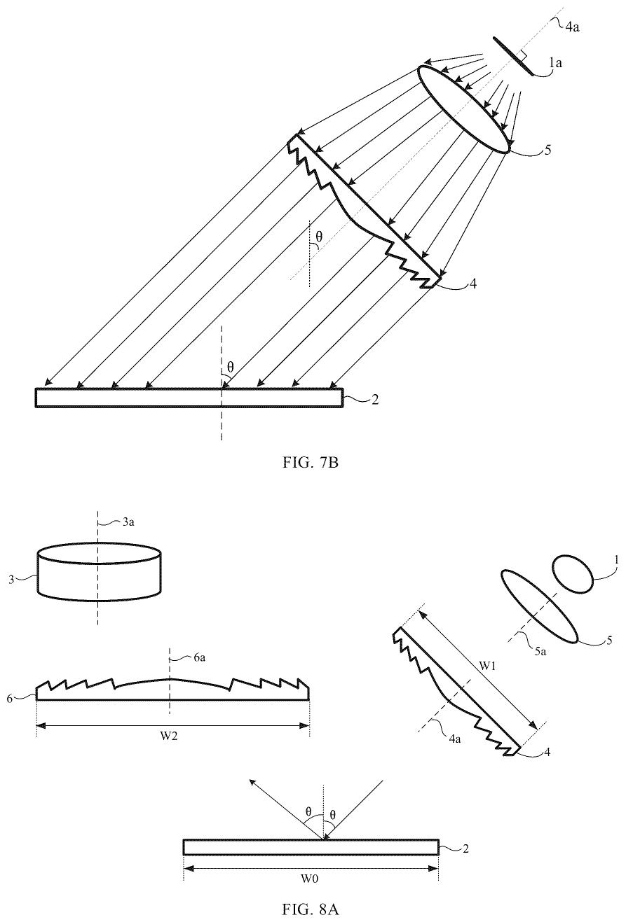

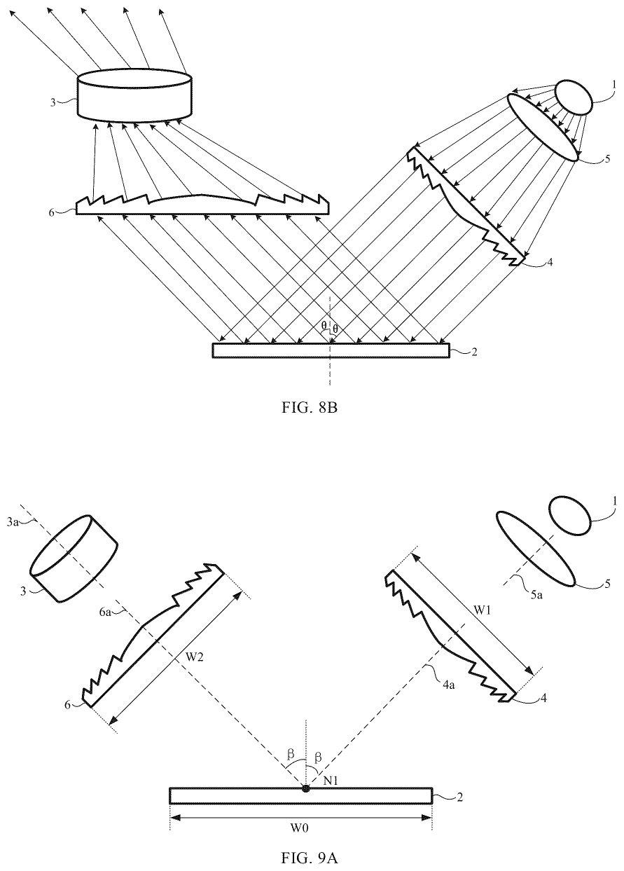

FIG. 8A is a schematic diagram of a structure of another projection apparatus according to an embodiment of the present disclosure; FIG. 8B is a schematic diagram of an optical path of the projection apparatus shown in FIG. 8A. As shown in FIGS. 8A and 8B, in some implementations, the projection apparatus further includes: a second light focusing component 6, the second light focusing component 6 is positioned between the projection lens 3 and the liquid crystal display panel 2, and is configured to focus the light irradiated to the second light focusing component 6 to the projection lens 3.

In the embodiment of the present disclosure, the second light focusing component 6 is disposed between the projection lens 3 and the liquid crystal display panel 2, so that the light utilization rate can be effectively improved, and miniaturization of the projection lens 3 can be realized.

In some implementations, an angle (i.e. the reflection angle of reflected light) formed between the collimated light reflected by the liquid crystal display panel 2 and received by the second light focusing component 6 and the normal of the liquid crystal display panel 2, and the angle (i.e. the incident angle of incident light) formed between the collimated light emitted by the collimating and light-extracting element 4 toward the liquid crystal display panel 2 and the normal of the liquid crystal display panel 2 are equal to each other.

As can be seen from the foregoing description of FIG. 6, in a case where the incident angle θ of light incident to the liquid crystal display panel 2 is constant, the maximum color gamut can be obtained by acquiring the reflected light at the reflection angle of θ. Therefore, with the above design, a high color gamut is advantageously realized.

In some implementations, an optical axis 6a of the second focusing component 6 is parallel to an optical axis 3a of the projection lens 3. With such design, the light utilization rate can be improved.

In some implementations, the second light focusing means 6 includes a second Fresnel lens. The second Fresnel lens may include: a central portion corresponding to a circular shape at a center of a Fresnel zone and an annular portion corresponding to an annular shape of the Fresnel zone.

With continued reference to FIGS. 8A and 8B, in some implementations, the optical axis 6a of the second light focusing component 6 is parallel to the normal of the liquid crystal display panel 2. That is, the second Fresnel lens is entirely parallel to the liquid crystal display panel 2. With such design, the picture displayed on the liquid crystal display panel 2 can be completely and reliably received by the second Fresnel lens. However, the reflected light of the liquid crystal display panel 2 is not parallel to the optical axis 6a of the second light focusing component 6, and thus such solution affects the light utilization rate to a certain extent.

In some implementations, the collimating and light-extracting component 4 includes the first Fresnel lens and the second light focusing component 6 includes the second Fresnel lens: a diameter of the first Fresnel lens is W1, a diameter of the second Fresnel lens is W2, and W1≤W2.

In some implementations, a maximum width of a display region of the liquid crystal display panel 2 is W0, and W1≤W0≤W2.

In the embodiment shown in FIG. 8A, an incident light beam desired by the liquid crystal display panel 2 is incident at a certain angle θ, and a minimum width of the incident light beam desired by the liquid crystal display panel 2 is W0×sin θ, and thus a minimum diameter of the first Fresnel lens may be W0×sin θ, and W1 may be less than or equal to W0. In order to ensure that the second Fresnel lens can completely receive the light reflected from various positions of the liquid crystal display panel 2, the minimum diameter of the first Fresnel lens may be W0, and therefore, W2 may be less than or equal to W0. That is, W1≤W0≤W2.

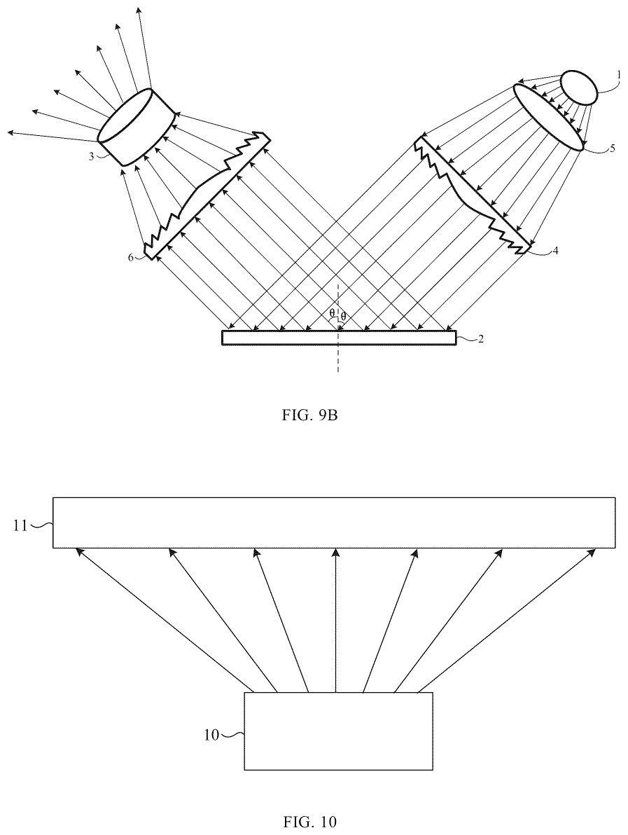

FIG. 9A is a schematic diagram of a structure of another projection apparatus according to an embodiment of the present disclosure: FIG. 9B is a schematic diagram of an optical path of the projection apparatus shown in FIG. 9A. As shown in FIGS. 9A and 9B, unlike the embodiment shown in FIG. 8A in which the optical axis 4a of the collimating and light-extracting component 4 is parallel to the normal of the liquid crystal display panel 2, in the embodiment shown in FIG. 9A, an angle β is formed between the optical axis 4a of the collimating and light-extracting component 4 and the normal of the liquid crystal display panel 2. B is an acute angle, and a predetermined angle β is formed between the optical axis 6a of the second light focusing component 6 and the normal of the liquid crystal display panel 2: the optical axis 6a of the second light focusing component 6 and the optical axis 4a of the collimating and light-extracting component 4 intersect at a first node N1, and an angle 2β is formed between a ray directed from the first node N1 to the second light focusing component 6 along the optical axis 6a of the second light focusing component 6, and a ray directed from the first node N1 to the collimating and light-extracting component 4 along the optical axis 4a of the collimating and light-extracting component 4.

In the embodiment of the present disclosure, with the above arrangement, the incident light of the liquid crystal display panel 2 is parallel to the optical axis 4a of the collimating and light-extracting component 4, and the reflected light of the liquid crystal display panel 2 is parallel to the optical axis 6a of the second light focusing component 6.

Compared with the embodiment shown in FIG. 8A in which the reflected light of the liquid crystal display panel 2 is not parallel to the optical axis 6a of the second light focusing component 6, in the embodiment shown in FIG. 9A, the reflected light of the liquid crystal display panel 2 is parallel to the optical axis 6a of the second light focusing component 6, which can effectively improve the light utilization rate.

In some implementations, the first node N1 is a center of the liquid crystal display panel 2. That is, the optical axis 6a of the second light focusing component 6 intersects the optical axis 4a of the collimating and light-extracting component 4 at the center of the liquid crystal display panel 2. With the above arrangement, miniaturization of the second light focusing component 6 and the collimating and light-extracting component 4 can be realized, which will be described in detail later.

In some implementations, the collimating and light-extracting component 4 includes the first Fresnel lens and the second light focusing component 6 includes the second Fresnel lens: a diameter of the first Fresnel lens is W1, a diameter of the second Fresnel lens is W2, and W1≤W2.

In some implementations, a maximum width of a display region of the liquid crystal display panel 2 is W0, and W1≤W0≤W2.

In the embodiment shown in FIG. 9A, an incident light beam desired by the liquid crystal display panel 2 is incident at a certain angle θ, and a minimum width of the incident light beam desired by the liquid crystal display panel 2 is W0×sin θ, and thus a minimum diameter of the first Fresnel lens may be W0×sin θ, and W1 may be less than or equal to W0. In a case where an optical axis of the first Fresnel lens passes through the center of the liquid crystal display panel 2, the diameter of the first Fresnel lens may be a minimum value W0×sin θ, i.e., the minimization of the first Fresnel lens is realized.

In addition, a width of reflected light beam reflected by the liquid crystal display panel 2 is W0×sin θ, so that a minimum diameter of the second Fresnel lens may be W0×sin θ, and W2 may be less than or equal to W0. In a case where an optical axis of the second Fresnel lens passes through the center of the liquid crystal display panel 2, a diameter of the second Fresnel lens may be a minimum value W0×sin θ, i.e., the minimization of the second Fresnel lens is realized.

In some implementations, the projection apparatus may be a projector.

In some implementations, the projection apparatus may be any product or component with display and projection functions, such as a mobile phone, a tablet computer, a television, a display, a notebook computer, a navigator or the like Here, the embodiment of the present disclosure does not limit the type of the projection apparatus. Other essential components of the projection apparatus are to be included as understood by those ordinary skills in the art, are not described herein, and should not be construed as limiting the present disclosure.

FIG. 10 is a schematic diagram of a structure of a display system according to an embodiment of the present disclosure. As shown in FIG. 10, the display system includes the projection apparatus 11 provided in the above embodiment, and for the specific description of the projection apparatus 11, reference may be made to the contents in the foregoing embodiment, and details are not repeated here.

In some implementations, the display system further includes a projection screen 12 on the light outgoing side of the projection lens. In some implementations, a plane where the projection screen is located is perpendicular to the optical axis of the projection lens. With such arrangement, the light utilization rate can be improved.

It should be understood that the above embodiments are merely exemplary embodiments adopted to explain the principles of the present disclosure, and the present disclosure is not limited thereto. It will be apparent to those ordinary skills in the art that various changes and modifications may be made without departing from the spirit and scope of the present disclosure, and such changes and modifications also fall within the scope of the present disclosure.

1. A projection apparatus, comprising:
a light emitting component configured to generate light;
a liquid crystal display panel on a light outgoing side of the light emitting component, and comprising a first substrate, a second substrate and a liquid crystal layer between the first substrate and the second substrate, the liquid crystal layer comprising cholesteric liquid crystals, and the cholesteric liquid crystals being configured to be in a conical helix texture under an electric field applied, so as to reflect light matched with a helix pitch of the conical helix texture;
an optical component between the light emitting component and the liquid crystal display panel, and configured to adjust a propagation direction of light, an angle between an optical axis of the optical component and a normal of the liquid crystal display panel being an acute angle; and
a projection lens configured to receive and project the light reflected by the liquid crystal display panel.

2. The projection apparatus of claim 1, wherein the optical component comprises:
a collimating and light-extracting component, the collimating and light-extracting component is between the light emitting component and the liquid crystal display panel, and is configured to adjust light irradiated to the collimating and light-extracting component into the collimated light and emit the collimated light to the liquid crystal display panel.

3. The projection apparatus of claim 2, wherein the collimating and light-extracting component comprises a first Fresnel lens.

4. The projection apparatus of claim 2, wherein the optical component further comprises:
a first light focusing component, the first light focusing component is between the light emitting component and the collimating and light-extracting component, and is configured to focus the light irradiated to the first light focusing component to the collimating and light-extracting component.

5. The projection apparatus of claim 4, wherein an optical axis of the collimating and light-extracting component and an optical axis of the first light focusing component are on a same straight line.

6. The projection apparatus of claim 2, further comprising:
a second light focusing component, the second light focusing component is between the projection lens and the liquid crystal display panel, and is configured to focus the light irradiated to the second light focusing component onto the projection lens.

7. The projection apparatus of claim 6, wherein an optical axis of the second focusing component is parallel to an optical axis of the projection lens.

8. The projection apparatus of claim 7, wherein the second light focusing component comprises a second Fresnel lens.

9. The projection apparatus of claim 6, wherein an optical axis of the second light focusing component is parallel to the normal of the liquid crystal display panel.

10. The projection apparatus of claim 9, wherein the collimating and light-extracting component comprises a first Fresnel lens and the second light focusing component comprises a second Fresnel lens; and
a diameter of the first Fresnel lens is W1, and a diameter of the second Fresnel lens is W2, and W1≤W2.

11. The projection apparatus of claim 10, wherein a maximum width of a display region of the liquid crystal display panel is W0, and W1≤W0≤W2.

12. The projection apparatus of claim 6, wherein an angle β is formed between an optical axis of the collimating and light-extracting component and the normal of the liquid crystal display panel, β is an acute angle,
an angle formed between an optical axis of the second light focusing component and the normal of the liquid crystal display panel, is equal to the angle formed between the optical axis of the collimating and light-extracting component and the normal of the liquid crystal display panel; and
the optical axis of the second light focusing component and the optical axis of the collimating and light-extracting component intersect at a first node, and an angle 2β is formed between a ray directed from the first node to the second light focusing component along the optical axis of the second light focusing component, and a ray directed from the first node to the collimating and light-extracting component along the optical axis of the collimating and light-extracting component.

13. The projection apparatus of claim 12, wherein the first node is a center of a display region of the liquid crystal display panel.

14. The projection apparatus of claim 12, wherein the collimating and light-extracting component comprises a first Fresnel lens and the second light focusing component comprises a second Fresnel lens; and
a diameter of the first Fresnel lens is W1, a diameter of the second Fresnel lens is W2, and W2≤W1.

15. The projection apparatus of claim 14, wherein a maximum width of a display region of the liquid crystal display panel is W0, and W2≤W1≤W0.

16. The projection apparatus of claim 6, wherein an angle formed between the collimated light reflected by the liquid crystal display panel and received by the second light focusing component and the normal of the liquid crystal display panel, and an angle formed between the collimated light emitted by the collimating and light-extracting element toward the liquid crystal display panel and the normal of the liquid crystal display panel are equal to each other.

17. The projection apparatus of claim 2, wherein an angle θ is formed between the collimated light emitted from the collimating and light-extracting component toward the liquid crystal display panel and the normal of the liquid crystal display panel; 0°<θ≤80°, or 30°≤θ≤70°, or 45°≤θ≤60°.

18. (canceled)

19. (canceled)

20. The projection apparatus of claim 17, wherein an angle β is formed between an optical axis of the collimating and light-extracting component and the normal of the liquid crystal display panel, β=θ.

21. The projection apparatus of claim 1, wherein the first substrate comprises a first base substrate, a first electrode on a side of the first base substrate facing the second substrate, and a first alignment layer on a side of the first electrode away from the first base substrate;
the second substrate comprises a second base substrate, a driving functional layer on a side of the second base substrate facing the first substrate, a plurality of second electrodes on a side of the driving functional layer away from the second base substrate, and a second alignment layer on a side of the plurality of second electrodes away from the second base substrate; and
the driving functional layer comprises a plurality of driving circuits in one-to-one correspondence with the plurality of second electrodes, each driving circuit is connected to the second electrode corresponding thereto, and configured to supply a pixel voltage to the second electrode.

22. (canceled)

23. A display system, comprising:
the projection apparatus of claim 1; and
a projection screen on a light outgoing side of the projection lens.

24. (canceled)
